(19) United States
(12) Patent Application Publication
(10) Pub. No.: US 2007/0271531 A1
(43) Pub. Date: Nov. 22, 2007

(54) Interactive interface and associated method adapted for user setting

(76) Inventor: Yun-Hsiang Chuang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/435,717

(22) Filed: May 18, 2006

(51) Int. Cl. G06F 17/00

(52) U.S. Cl. 715/846

(57) ABSTRACT

The present invention is directed to an interactive user setting interface, which includes a function are a having function icons that are arranged according to a setting sequence. The interactive user setting interface also includes an option area having option icons respectively corresponding to the function icons, each of the option icons providing at least one option to be selected. The function icons and the option icons are selectively opened according to a user setting, and the options provided by each option icon is distinct according to the user setting.

### BACKGROUND OF THE INVENTION

1. Field of the Invention

The present invention generally relates to an interactive user setting interface and associated setting method, and more particularly to an interactive user setting interface and associated setting method for a handheld multimedia recorder/player.

2. Description of the Related Art

Among diversity of modern electronic devices, the quality and quantity of their functions are decisive factors affecting their success in the market. On the other hand, there is a growing trend toward small-size or portability. The quantity of functions and the small-size trend are often contrary to each other in designing the electronic devices, and they more or less need compromise. Even though a small-sized electronic device equipped with a screen through which a user could perform setting among various functions becomes possible, however, the user always encounters difficulty, inconvenience, and even confusion while performing setting primarily because these functions are distributed in parallel. Specifically, most of these functions are independently provided, and there is lack of interconnection and sequence among the functions, and there is absence of guidance leading the user through the complex setting. Accordingly, the user performs the setting successfully only by experience or luck. Usually, the user feels frustrated for omitting some settings, repeating some settings, making an invalid setting, or not knowing what to set.

To take a video recorder/player as an example, it usually has two main functions: “play” and “record.” After one of them is selected, the user needs further set the start time and its sustained time. Furthermore, the user needs select one from numerous video/audio sources, and choose one from various contents associated with the selected source. To make things more complicated, the sources and contents for the function “play” are quite different from those for the function “record.” For example, the source “photo” is playable but not recordable; and the source “microphone” is a record-related source, but not a play-related source. All those dissimilarities make the user confused and inconvenient, resulting in setting error and waste of time.

For the disadvantages described above, a need has arisen to propose a user interface for guiding the user through function setting effortlessly and accurately.

### SUMMARY OF THE INVENTION

In view of the foregoing, it is an object of the present invention to provide an interactive user setting interface and associated setting method, so that the user can effortlessly and accurately perform the setting. Accordingly, the user no longer omits some settings, repeats some settings, makes an invalid setting, or does not know what to set as in the conventional setting.

According to the object, the present invention provides an interactive user setting interface, which includes a function area having function icons for respectively representing individual function to be set. The function icons are arranged according to a setting sequence. The interactive user setting interface also includes an option area having option icons respectively corresponding to the function icons, each of the option icons providing at least one option to be selected. The function icons and the option icons are selectively opened according to a user setting, and the options provided by each option icon is distinct according to the user setting.

### BRIEF DESCRIPTION OF THE DRAWINGS

FIG. 1 shows a displayed event list user interface according to the embodiment of the present invention;

FIG. 2 shows a setting interface according to the embodiment of the present invention; and

FIG. 3 shows a flow of the operation and display of the setting interface of FIG. 2.

### DETAILED DESCRIPTION

One embodiment of the present invention described below is exemplified by a handheld multimedia recorder/player. However, the present invention is quite well adapted for other electronic devices, especially the small-sized or portable electronic devices that have limited internal resource. Such electronic devices utilizing the present invention will manifest their convenience in operation as compared to conventional ones.

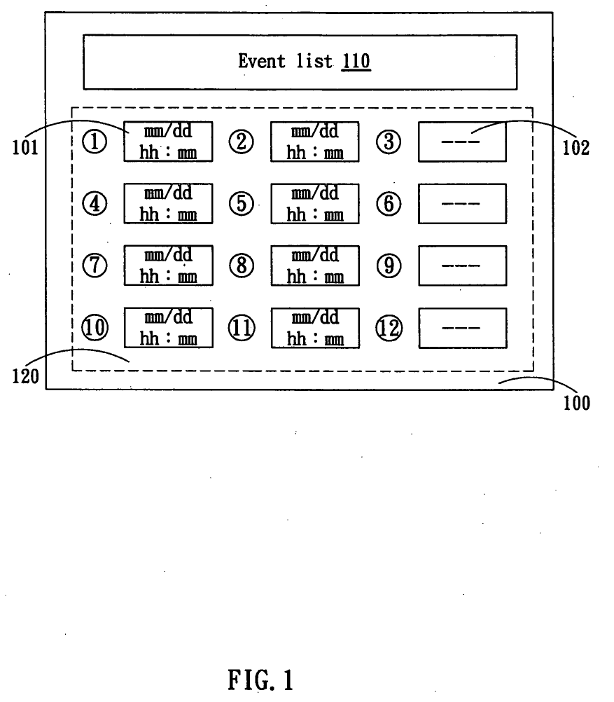

FIG. 1 shows a displayed event list user interface (abbreviated as event list interface hereinafter) 100 according to the embodiment of the present invention. In addition to a title of the event list 110, the event list interface 100 includes an event timer group area 120 displaying event icons (or event timers) respectively with identified serial number. These event icons are categorized into two classes: ON event 101 and OFF event 102. The icon of the ON event 101 displays, for example, corresponding month/day/hour/minute in a format of mm/dd hh:mm. The icon of the OFF event 102 displays symbols “- - - ” or nothing.

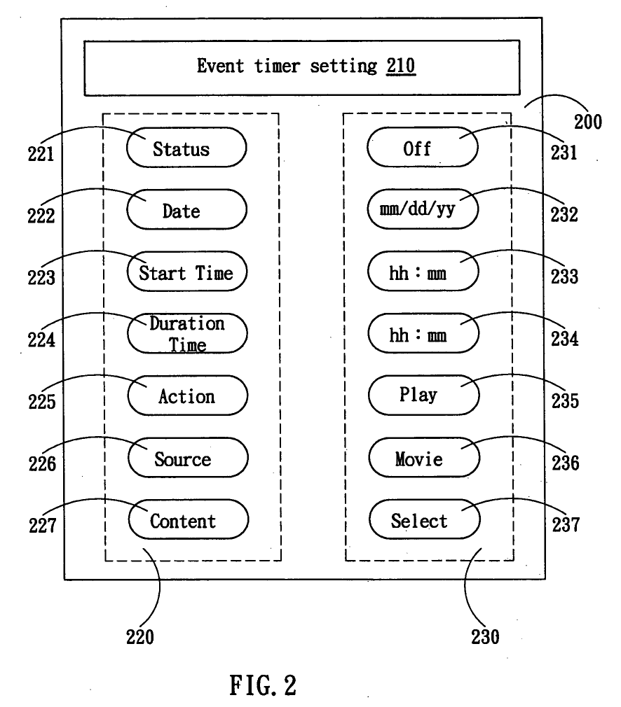

When a user clicks or selects one of the events 101 and 102, a setting interface corresponding to the selected event appears. It is appreciated that the setting interface could be displayed with the event list interface 100 on the same display page, or could be displayed on another new display page. FIG. 2 shows a setting interface 200 according to the embodiment of the present invention. In this embodiment, the setting page 200 is notably an interactive user setting interface. In addition to a title 210 identifying its corresponding event timer 101 or 102, the setting interface 200 includes two areas: function area 220 and option area 230. Each of the areas has icons 221-227 (also called function icons) and 231-237 (also called option icons). It is appreciated that the function icons 221-227 in the function area 220 are particularly arranged according to the characteristics of the setting, such as the setting sequence. Each option icon 231-237 in the option area 230 corresponds with the nearby function icon 221-227, and they are paired together in operation. For example, the icon “Status” 221 and the icon 231 belong to a pair, and the icon “Date” 222 and the icon 232 belong to another pair.

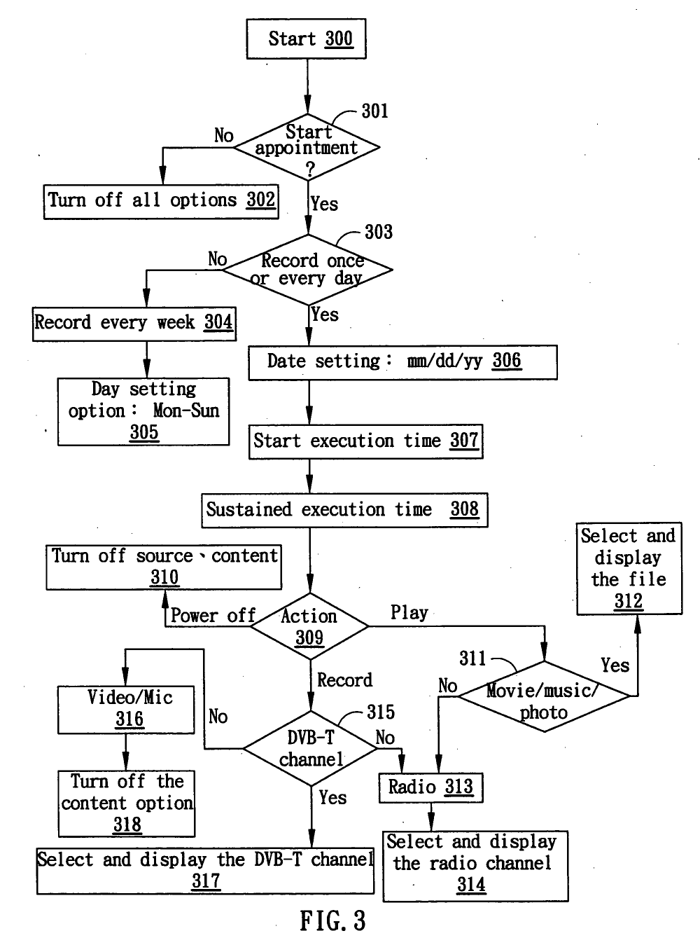

The operation and display of the setting interface 200 is described below accompanying by FIG. 3, which illustrates a flow of the operation and display of the setting interface 200. At the beginning, the user selects one of the events 101-102, and the setting interface 200 (FIG. 2) corresponding to the selected event thus appears, thereby starting the setting (step 300) and then making appointment (step 301). The icon 231 corresponding to the icon “Status” 221 has four options: “off,” “once,” “every day,” and “every week.” While only “off” is shown in the figure, other options can be displayed, for example, by pressing a direction key installed on the electronic device. If the user selects the option “off” (that is, the “No” branch of step 301) to disable the setting, all the following function icons 222-227 and option icons 232-237 are closed or turned off (step 302). In the embodiment, the icons that are closed are dimly displayed, or thoroughly hidden. If the user selects the option “once” or “every day” to enable the setting and make a record appointment once or every day (that is, the “Yes” branch of step 303), all the following function icons 222-227 and option icons 232-237 are open or turned on, and the icon 232 displays “mm/dd/yy” (step 306) waiting for the user to input month/day/year. If the user selects the option “every week” (step 304) to enable the setting, the icon 232 displays “Mon-Sun” (not shown in FIG. 2) (step 305), waiting for the user to select one of the day.

Afterwards, the user performs the function “Start Time” 223 setting and sets the start time through the icon 233 (step 307). Subsequently, the user performs the function “Duration Time” 224 setting and sets the sustained time through the icon 234 (step 308).

Next, the user performs the function “Action” 225 setting and selects one of the following options through the icon 235 (step 309): “Play,” “Record,” and “Power off.” If the user selects the option “Power off,” the functions “Source” 226 and “Content” 227 and the corresponding icons 236-237 are turned off and dimly displayed (step 310). If the user selects the option “Play,” the icon 236 then provides following options: “Movie,” “Music,” “Photo” (step 311), and “Radio” (step 313). If the option “Movie,” “Music,” or “Photo” is selected, the user subsequently performs the function “Content” 227 setting by selecting one of the files and then displaying it on the screen (step 312); if the option “Radio” is selected instead, the user subsequently performs the function “Content” 227 setting by selecting one of the radio channels and then displaying it on the screen (step 314).

Referring back to the function “Action” 225 described above, if the user selects the option “Record,” the icon 236 then provides following options: “Video,” “Mic (Microphone)” (step 316), “Radio” (step 313), and “DVB-T (Digital Video Broadcasting)” (step 315). If the option “Video” or “Mic” is selected, the function “Content” 227 and the corresponding icon 237 are turned off (step 318); if the option “DVB-T” is selected instead, the user subsequently performs the function “Content” 227 setting by selecting one of the DVB-T channels and then displaying it on the screen (step 317); if the option “Radio” is selected instead, the user subsequently performs the function “Content” 227 setting by selecting one of the radio channels and then displaying it on the screen (step 314).

The flow and the setting interface 200 described above integrate all of the function icons 221-227 on the same user interface, and these icons 221-227 are particularly arranged according to the setting sequence. Notably, the setting interface 200 selectively opens relevant function icons and option icons according to the user setting. Moreover, the corresponding options provided in the option icons are distinct according to specific function that is set. For example, if the user selects the option “Play,” the icon 236 then provides following options: “Movie,” “Music,” “Photo,” and “Radio”; if the user selects the option “Record,” the icon 236 then provides following options: “Video,” “Mic,” “Radio,” and “DVB-T.” Through the guidance of the setting interface 200 during the user setting, the user no longer omits some settings, repeats some settings, makes an invalid setting, or does not know what to set as in the conventional setting.

Although specific embodiments have been illustrated and described, it will be appreciated by those skilled in the art that various modifications may be made without departing from the scope of the present invention, which is intended to be limited solely by the appended claims.

What is claimed is

1. An interactive user setting interface, comprising:
a function area including a plurality of function icons for respectively representing individual function to be set, the function icons being arranged according to a setting sequence; and
an option area including a plurality of option icons, each of the option icons being corresponding to one of the function icons, and each of the option icons providing at least one option to be selected;
wherein the function icons and the option icons are selectively opened according to a user setting, and said at least one option provided by each of the option icons is distinct according to the user setting.

2. The interactive user setting interface of claim 1, further comprising a title identifying an event that is corresponding to a present display page of the interactive user setting interface.

3. The interactive user setting interface of claim 2, further comprising an event list interface, which includes a plurality of event icons, one of which is corresponding to the present display page of the interactive user setting interface.

4. The interactive user setting interface of claim 1, wherein a plurality of the options provided by the option icons are displayable by pressing an installed key.

5. An interactive user setting method for a handheld multimedia recorder/player, comprising:
providing a setting interface which displays a plurality of function icons for respectively representing individual function to be set, the function icons being arranged according to a setting sequence, and said setting interface displays a plurality of option icons, each of the option icons being corresponding to one of the function icons, and each of the option icons providing at least one option to be selected;
selecting one of a plurality of status options to enable a setting, wherein if the setting is not enabled, the function icons other than the status functions are turned off;
performing a date function to set a date, if the setting is enabled;
performing a time function to set a time;
performing an action function, and then a plurality of the options related to action are provided for select;
performing a source function, and then a plurality of the options related to source are provided for select; and
performing a content function, and then a plurality of the options related to content are provided for select;
wherein the function icons and the option icons are selectively opened according to the setting, and said at least one option provided by each of the option icons is distinct according to the setting

6. The method of claim 5, further comprising a title identifying an event that is corresponding to a present display page of the setting interface.

7. The method of claim 6, further comprising an event list interface, which includes a plurality of event icons, one of which is corresponding to the present display page of the setting interface.

8. The method of claim 5, wherein a plurality of the options provided by the option icons are displayable by pressing an installed key.

9. The method of claim 5, wherein said status options comprise “off,” “once,” “every day,” and “every week.”

10. The method of claim 5, wherein said plurality of the options related to action comprise “Play,” “Record,” and “Power off.”

11. The method of claim 10, when the “Play” is selected, then said plurality of the options related to source comprise “Movie,” “Music,” “Photo,” and “Radio.”

12. The method of claim 10, when the “Record” is selected, then said plurality of the options related to source comprise “Video,” “Mic,” “Radio,” and “DVB-T.”

13. The method of claim 10, when the “Power off” is selected, then turning off said plurality of the options related to source and content.

14. The method of claim 11, when the “Movie,” “Music,” or “Photo” is selected, then displaying a file to be selected.

15. The method of claim 11, when the “Radio” is selected, then displaying a radio channel to be selected.

16. The method of claim 12, when the “Video” or “Mic” is selected, then turning off said plurality of the options related to content.

17. The method of claim 12, when the “Radio” is selected, then displaying a radio channel to be selected.

18. The method of claim 12, when the “DVB-T” is selected, then displaying a DVB-T channel to be selected.
